(19) United States
(12) Patent Application Publication
(10) Pub. No.: US 2007/0183604 A1
(43) Pub. Date: Aug. 9, 2007

(54) Response to anomalous acoustic environments

(75) Inventors: M. Sam Araki, Saratoga, CA (US); Ashim Banerjee, Westminster, CO (US); Peter Coe Verbica, Santa Cruz, CA (US); Mobeen Bajwa, Fremont, CA (US); Safwan Shah, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ST-Infonox, San Jose, CA (US)

(21) Appl. No.: 11/351,893

(22) Filed: Feb. 9, 2006

(51) Int. Cl. H04R 5/00

(52) U.S. Cl. 381/58; 381/17

(57) ABSTRACT

Methods and system are described for monitoring an environment. Acoustic data collected from microphones distributed within the environment are received. Sound sources are identified from the received acoustic data as generative of sound detected by the microphones. An acoustic scene of the environment is characterized by application of acoustic-scene characterization rules to the received acoustic data. The acoustic scene of the environment is identified as anomalous according to parameter values deviant from a set of parameter values defining nonanomalous acoustic scenes. A remedial response to the environment is initiated in response to identifying the acoustic scene of the environment as anomalous.

### BACKGROUND OF THE INVENTION

This application relates generally to methods and systems for monitoring environments. More specifically, this application relates to methods and systems for responding to an identification of an anomalous acoustic environment.

As used herein, an “environment” is limited physical area. Examples of environments include individual rooms, such as within a house or an office, or may include an entire building structure such as a house, an apartment building, or an office building. Other examples of environments may include business locations, either indoors or outdoors, including retail establishments, public-transport terminals like bus stations, train stations, airports, seaports, etc. While these are examples of stationary environments, other environments may be in motion. Examples of such environments include vehicles such as cars, trains, airplanes, ships, buses, and the like.

There are numerous reasons for monitoring environments, some of which may be more relevant to certain environments than others and some of which may be of generally more importance to some parties than others. A particularly common reason for monitoring environments is to ensure the security of the environment itself, whether the potential threat to the environment's security is from destructive forces like fire or flood, or from illegal human activity like theft, vandalism, arson, or the like. Another common reason for monitoring environments is to ensure the security of people who live or work in the environment and who may be at risk from the some types of potential threats. Other reasons for monitoring environments include surveillance reasons at a variety of different levels, spanning monitoring of teenager activity by parents to monitoring of precursors to criminal or terrorist activity by different levels of government.

Currently, one of the most common ways of monitoring environments is through the use of video cameras that collect a video record of activity in the environment. Such approaches tend to be passive in that the video record is reviewed only after the occurrence of some problem as part of an investigative procedure. In other instances, a human monitors the video stream from the video cameras in real time, permitting intervention when the human identifies circumstances that suggest some problem is imminent, such as where the human sees early indications of smoke in a room or sees an intruder in a room. The benefits of such uses of video surveillance are thus limited by the need for human involvement to permit early identification of potential problems and intervention to prevent them. While some efforts have been made in the art to perform scene analysis of video content, such efforts are constrained by the very large data content that video provides.

Other efforts to monitor environments have used different types of sensors that function without significant human involvement to identify potential problems. Examples of such sensors include smoke detectors, heat detectors, carbon monoxide detectors, glass-breaking monitors, pool-alarm monitors, motion detectors, and the like. The paradigm used by such detectors is that what the presence of what they detect is suggestive of an anomaly in the environment—detecting smoke suggests that there is a fire, detecting motion suggests the presence of an intruder, activation of the carbon monoxide detector suggests the presence of potentially harmful levels of carbon monoxide, etc. But it is well known that these kinds of devices are prone to activation because of other factors—heat and smoke detectors may be activated because of normal cooking activity, motion detectors may detect the presence of pets, carbon monoxide detectors may respond to temperature inversions, etc. The value of such detectors is thus very much limited because they fail to account for context when they are activated. Responding to the alarms issued by such devices when they have such reactions is inconvenient and potentially costly by adversely affecting productivity of the individuals who respond.

There is accordingly a general need in the art for improved methods and systems of monitoring environments and identifying the occurrence of anomalies in the environments.

### BRIEF SUMMARY OF THE INVENTION

Embodiments of the invention provide methods and systems for monitoring an environment that use acoustic data to develop an acoustic scene of the environment, permitting the identification of anomalous characteristics of the scene and the initiation of an appropriate remedial response. The use of acoustic data advantageously avoids the very high bandwidth requirements associated with video monitoring and the development of an acoustic scene allows the relative influence of different, and potentially competing, indicators to be used in increasing the accuracy of monitoring determinations.

Thus, in method embodiments of the invention, acoustic data collected from a plurality of microphones distributed within the environment are received. Sound sources are identified from the received acoustic data as generative of sound detected by the microphones. An acoustic scene of the environment is characterized by application of acoustic-scene characterization rules to the received acoustic data. The acoustic scene of the environment is identified as anomalous according to parameter values deviant from a set of parameter values defining nonanomalous acoustic scenes. A remedial response to the environment is initiated in response to identifying the acoustic scene of the environment as anomalous.

In some such embodiments, a quality of each of the identified sound sources may be determined by application of sound-quality rules to the received acoustic data. In such instances, the acoustic scene of the environment is further characterized by application of the acoustic-scene characterization rules to the determined quality of the identified sound sources. The sound-quality rules may comprise fuzzy-logic rules, with the quality of each of the identified sound sources being determined by applying the fuzzy-logic rules to the received acoustic data.

There are numerous examples of sound sources that may be identified and qualities of those sound sources that may be determined. For instance, in various embodiments, one of the sound sources comprises a human voice sound made by a human being and the quality of that sound source comprises a determined emotional state of the human being, determined physical characteristics of the human being, or determined demographic characteristics of the human being. Other human sounds that may be detected include footstep sounds, breathing sounds, and the like. In another embodiment, one of the sound sources comprises an alarm device, with the quality of that sound source comprising an active alarm state of the alarm device. In other cases, one of the sound sources may comprise atmospheric weather, with the quality of that sound source comprising weather conditions around the environment. In still another example, one of the sound sources comprises a siren outside the environment, with the quality of that sound source comprising a determined motion of the siren towards or away from the environment. Other examples of sounds that may be detected include animal sounds, glass breaking, appliance sounds, and the like.

More generally, embodiments of the invention may encompass circumstances where at least one of the identified sound sources is outside the environment. A result of the remedial response may be evaluate, allowing a second response to the environment to be initiated in accordance with such an evaluation. For instance, the remedial response to the environment could comprise activation of video monitoring of at least a portion of the environment.

A motion pattern of at least some of the identified sound sources within the environment may be determined in many instances by triangulating positions of those sound sources over time with the received acoustic data. The acoustic-characterization rules may themselves comprise fuzzy-logic rules so that characterization of the acoustic scene of the environment is achieved by applying the fuzzy-logic rules to the received acoustic data to perform a comparison of the received acoustic data with standardized sound signatures. In certain embodiments, data external to the environment is additionally received, allowing the acoustic scene of the environment to be further characterized by application of the acoustic-scene characterization rules to the data external to the environment.

Such methods of the invention may be embodied on a system having a plurality of microphones distributed within the environment, a sound-identification system in communication with the microphones, an acoustic-scene characterization system in communication with the sound-identification system, and a response system in communication with the acoustic-scene characterization system. The various systems include programming instructions to implement the methods as described above.

### BRIEF DESCRIPTION OF THE DRAWINGS

A further understanding of the nature and advantages of the present invention may be realized by reference to the remaining portions of the specification and the drawings wherein like reference labels are used throughout the several drawings to refer to similar components. In some instances, reference labels include a numerical portion followed by a latin-letter suffix; reference to only the numerical portion of reference labels is intended to refer collectively to all reference labels that have that numerical portion but different latin-letter suffices.

FIG. 1 provides a schematic diagram presenting an overview of a system used in one embodiment of the invention;

FIG. 2 provides an illustration of computational modules used in a system for monitoring environments in an embodiment;

FIG. 3 provides illustrations of how parameters from different types of measurements may be derived and combined according to a rules engine in monitoring an environment;

FIG. 4 is a flow diagram summarizing methods for monitoring an environment in embodiments of the invention; and

FIG. 5 provides a structural illustration of a computer system on which modules used by the invention may be embodied.

### DETAILED DESCRIPTION OF THE INVENTION

Embodiments of the invention make use of acoustic scene analyses to monitor environments and initiate responses when certain anomalies are detected in the environments. It is generally anticipated that the acoustic scene analyses proceed without the use of video information, thereby advantageously making use of the much lower data content provided with acoustic information, but in some embodiments a video component may also be included. Briefly, acoustic information is collected with microphones distributed throughout the environment and analyzed to identify parameters of interest. Correlations among these parameters, particularly as evaluated with a fuzzy-logic approach, permit the initiation of a response to identified anomalies in the environment.

In embodiments of the invention, the specific base content of the audio, such as conversational content, is not of interest per se. Instead, embodiments of the invention make use of audio output signatures from application of a configurable and integrated rules engine that may use fuzzy logic for evaluation. These audio signatures could be electronic, human, mechanical, animal, weather-related, etc., and contribute to the audio ambience of environment. Depending on the ambient environment or application of the rules, different inferences may be established, some being more complex that others. For example, at a low level of complexity, the sound of a smoke detector could be identified as such and used as part of an analysis of the environment. At a greater level of complexity, intonation of multiple human parties could be used to perform demographic assignments of the parties and to determine their emotional states, coupled with the use of acoustic information to evaluate motion patterns within the environment in characterizing a group behavior. Further specific examples of the types of analyses enabled by embodiments of the invention are described in additional detail as part of the descriptions that follow.

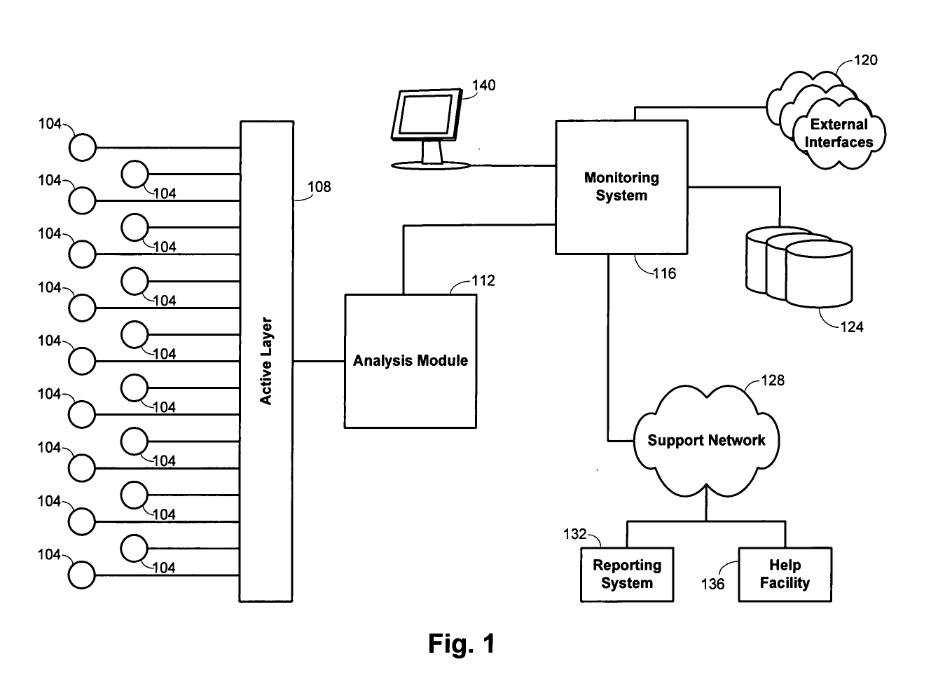

An initial overview of certain structural aspects of the invention is provided with the schematic illustration of FIG. 1. Acoustic data are collected with a plurality of microphones 104 distributed in the environment. Any suitable microphone structure may be used. While it is generally expected that the microphones 104 will be operational over a broad frequency range, there may be specialized embodiments in which the microphones 104 are designed to collect data over more narrow frequency ranges. In some instances, the range of the microphones 104 may include frequencies outside the range of normal human hearing. Furthermore, different embodiments may use microphones 104 having different sensitivity levels depending on the application. The distribution of the microphones 104 may depend on specific characteristics of the environment and on the monitoring objectives to be achieved.

Data collected by the microphones 104 may be provided to an analysis module 112 that performs operations on the data to characterize the environment acoustically. An intermediate active layer 108 may additionally be provided to permit coordination of information collected by the microphones 108. The active layer 108 comprises a suite of server and client resident software that enables data collection to be performed in an adaptable fashion, and is described in further detail for other applications in U.S. Pat. No. 6,947,902, the entire disclosure of which is incorporated herein by reference for all purposes. The active layer 108 also provides a mechanism by which adjusted weighting factors used in the fuzzy-logic analysis described below may be implemented to improve the generation of results by the analysis module 112.

Information derived by the analysis module 112 is provided to a monitoring system 116 that enables real-time oversight of the state of the environment. Usually such oversight is provided in an automated manner and permits a time evolution of the state of the environment to be used in identifying anomalies in the environment. In some instances, information derived from the collected acoustic data may, however, be used to generate a visual display on a monitor 140 for a user. Such a visual display may identify locations of individuals or objects in the environment as determined from the acoustic data, showing movement of the individuals or objects over time. The visual display may also be also include graphical icons to denote derived characteristics of the environment such as the presence of smoke, whether a device is on or off, whether plumbing is in use, etc.

The monitoring system 116 also acts as an interface through which additional functionality may be provided. For example, information may be maintained by the monitoring system 116 on databases 124. This information may include results of analyses used by the monitoring system, providing a historic record of the state of the environment, and/or may include information used in performing some of the analysis of the environment state. Such supplementary information may be drawn from external interfaces 120 and may include information that permits inferences to be drawn in evaluating the state of the environment. For instance, such supplementary information could include statistical information correlating emotional states of individuals to broad characteristics of speech patterns, providing data that permits the system to analyze speech patterns to deduce emotional states from such characteristics.

In addition, the monitoring system 116 may be interfaced with a support network 128 that allows access to the monitoring services by customers. For example, homeowners might subscribe to a monitoring service of their homes; businesses might subscribe to monitoring services of various business locations, including offices, retail outlets, manufacturing facilities, warehouses, and the like; governments might subscribe to monitoring services of various locations, such as public-transport terminals, tourist sites, government offices, courthouses, and the like. The versatility of the system to accommodate a variety of different types of acoustic analyses advantageously permits subscriptions provided by the monitoring services to be tailored to the individual applications. Not only may there be broad differences among the types of concerns presented by different types of environments, there may be individual concerns for specific environments, all of which may be accommodated. Interactions with customers who subscribe to such services may be provided with a reporting system 132 that may either generate periodic reports for customers or provide an interactive facility through which customers may access information regarding the state of a monitored environment in real time or historically. A help facility 136 enables customer-service operations to be provided with a mechanism for responding to customer inquiries about the results or operation of the system.

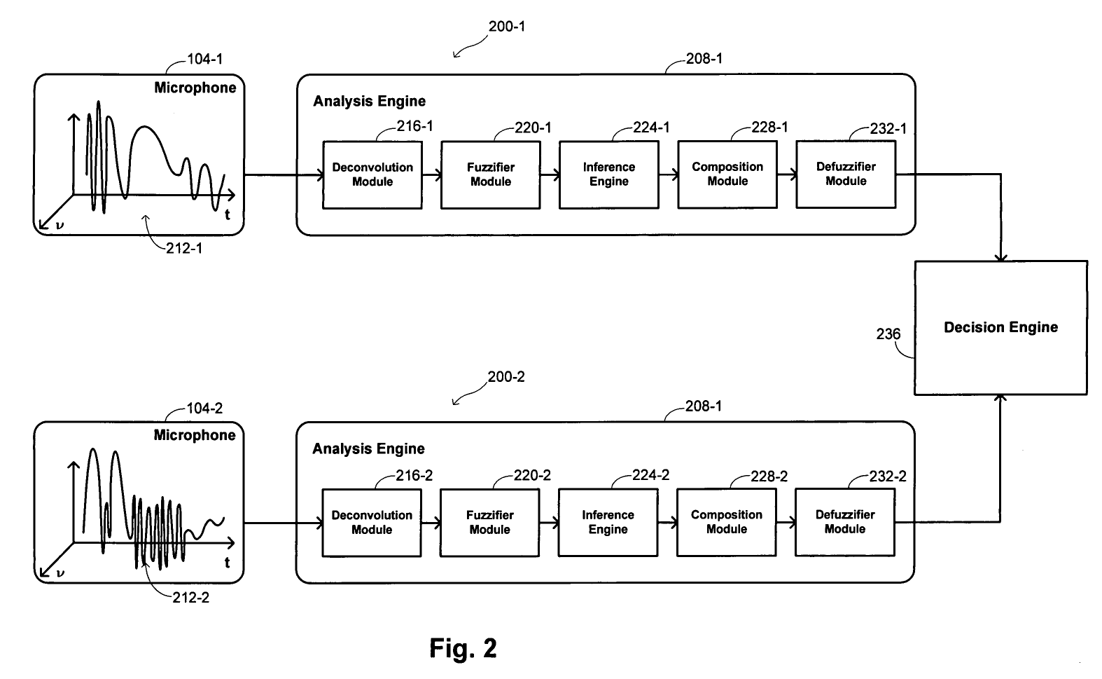

FIG. 2 is a schematic diagram that illustrates how analyses may be performed with the analysis module 112 and monitoring system 116. As will be appreciated by those of skill in the art, the division of tasks among the analysis module 112 and monitoring system 116 may be somewhat arbitrary, with different embodiments assigning different ones of the tasks to different ones of those components. The following discussion thus focuses on the functionality of the individual engines and modules illustrated in FIG. 2, with the understanding that they may be embodied by the analysis module 112 or monitoring system 116 as appropriate to a specific embodiment.

The drawing illustrates that information is provided to a decision engine 236 from a plurality of analysis engines 220, each of which collects acoustic data from a microphone 104. In one embodiment, the decision engine 236 might thus be comprised by the monitoring system 116, with each of the analysis engines 200 being comprised by the analysis module, although other configurations are possible. Although the drawing shows only two microphones and corresponding analysis being used to provide information to a decision engine 236, it is generally anticipated that a greater number of acoustic sources distributed through the environment will be used.

In general, the different physical placement of each microphone 104 in the environment will cause it to collect a different acoustic pattern 212, which may have variations in at least frequency and time. That is, at any given time t, the acoustic pattern 212 received by a microphone 104 will have an intensity distribution over a frequency range ν of the microphone 104. This intensity distribution varies over time as the state of the environment changes and the sounds being detected by the microphone change in response to the change in state.

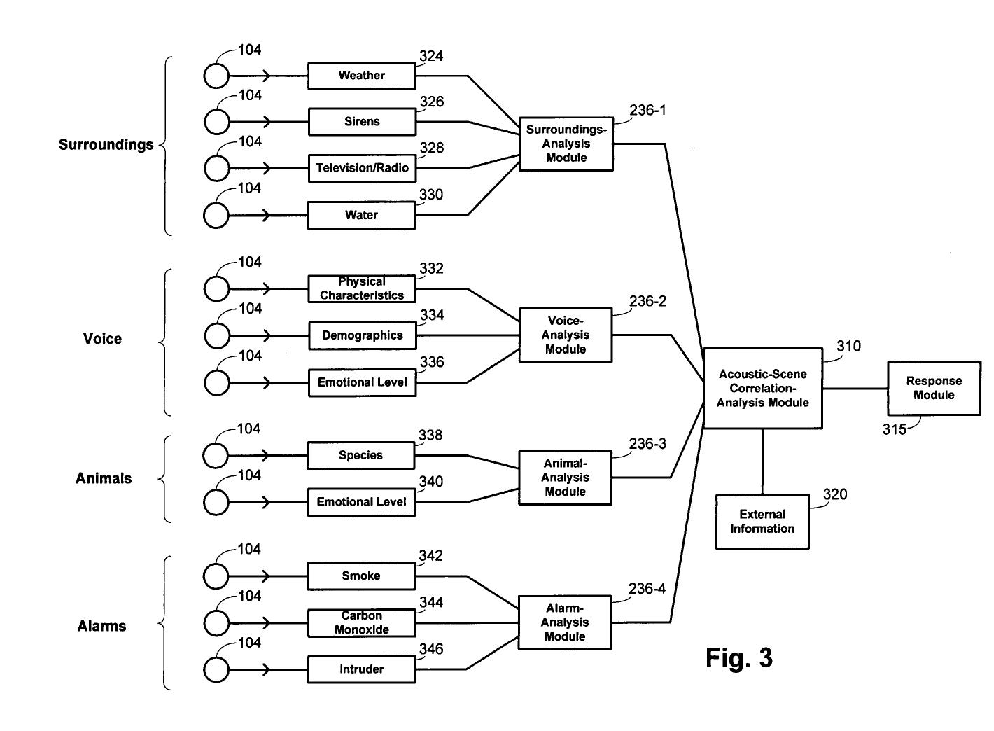

The time- and frequency-varying data from each microphone are provided to a respective analysis engine 200 that has a series modules that act interpretively on the acoustic data. That is, from the acoustic information received at a particular microphone 104, a conclusion is drawn by the analysis engine 200 characterizing the source(s) of the sounds received: whether the sound is natural or artificial, what type of device is making the sound, the physical characteristics of a person making the sound, whether the sound of a person is being made in the environment itself or transmitted to the environment such as through a television or radio, and/or the like. These types of conclusions may make use of contextual information that specifies such factors as the time of day, the day of the week, the weather conditions, etc. A further description of how sounds may be classified is provided in the discussion below of FIG. 3.

The analysis performed by the analysis engine 200 may begin with a deconvolution module 216 that identifies the frequency contributions to the acoustic signal. The deconvolved data are provided to a set of modules that implement fuzzy-logic techniques. Fuzzy logic generally includes a number of methods that allow decision-making processes to be implemented with inexact information, particularly where ambiguities in the information are nonstatistical in nature. In this instance, the application of fuzzy logic is well suited to characterizing the acoustic sources—identification and characterization of the sources ultimately relies on performing a comparison of the deconvolved data with standardized acoustic signatures to identify a correspondence. When the correspondence is identified, the collected acoustic data are inferred to have originated with a source like the known source that provided the acoustic signature. The application of fuzzy logic permits this process to be quantified with the contribution of a set of information to various parameters. Fuzzy logic may generally be viewed as a superset of Boolean logic in which Boolean truth values may be replaced with intermediate degrees of truth. Thus, while Boolean logic allows only for truth values of zero and one, fuzzy logic allows for truth values having any real number between zero and one.

The application of fuzzy logic may begin by determining a degree of membership of a crisp value from the deconvolved data into one or more fuzzy sets. The number of fuzzy sets that are used may depend on the type of environment being monitored and on the types of acoustic sources that are anticipated to be of interest in that type of environment. A fuzzifier module 220 comprises if-then rules that act to fuzzify the data. An interference engine 224 and a composition module 228 apply rules for activation and combination that map fuzzy sets into other fuzzy sets. A defuzzifier module 232 converts the resulting fuzzy sets into crisp values that may be used by the decision engine 236 in characterizing the acoustic sources giving rise to the collected acoustic data. The application of fuzzy-logic techniques is well known to those of skill in the art and is described in further detail in, for example, U.S. Pat. No. 5,307,443, entitled “APPARATUS FOR PROCESSING INFORMATION BASED ON FUZZY LOGIC,” the entire disclosure of which is incorporated herein by reference for all purposes. While the use of fuzzy logic has been noted as a particular technique used in certain embodiments of the invention, other embodiments may use any of a variety of alternative artificial-intelligence techniques, including expert systems, neural networks, genetic algorithms, and the like.

An illustration of the types of analyses that may be performed is illustrated in FIG. 3, in which the analysis are classified into four different categories. Such categorization is made merely for purposes of illustration and different embodiments may use different classifications and/or a different number of classifications. In each instance, the analysis of the acoustic information is performed using the modules described in connection with FIG. 2, performing a fuzzy-logic comparison with a standardized sound signature. Examples of factors that characterize the surroundings of the environment include weather characterizations 324, the identification of sirens 326, the identification of television or radio sounds 328, the presence of water sounds 330, and the like. For instance, a weather characterization 324 could identify the presence of wind and evaluate possible wind speed from the intensity of the wind sound, could identify the presence of rainfall or hail and its intensity, could identify the existence of thunder sounds, etc. All of these factors may provide an indication of the overall weather conditions at the time of collection of the acoustic data. The identification of sirens 326 may include identifying a motion pattern for a siren based on the intensity of its sound, i.e. provide an indication whether the siren is approaching the environment as evident from a persistently increasing sound intensity. In addition, certain sound patterns made by sirens are sometimes sufficiently distinctive to identify a type of emergency vehicle, such as a police car, an ambulance, or fire engine. The analysis of television and radio signals 328 may be used to draw inferences of the likelihood the environment is occupied and if coupled with some content analysis may provide demographic information about an occupant—the content of programming may be used to infer an age, sex, income level, etc. of a watcher. The presence of water sounds 330 may take a number of different forms. Water may be detected as running continuously, and the length of time that it runs may permit certain inferences to be drawn. It may be detected as associated with certain plumbing features, indicating the presence and activity of a person in the environment. It may be identified as consistent with a spray pattern, suggesting a puncture or leak in pipe. A surroundings-analysis module 236-1 is a form of decision engine that may combine information from these various surroundings sources to draw inferences about the environment.

Examples of voice characterizations include the identification of physical characteristics of speakers 352, a determination of demographics of speakers 334, an evaluation of an emotional level of speakers, etc. Such acoustic features as the frequency of a voice and the pattern of interspersing pauses in speech may provided information about the sex and age of a person, and may additionally provide information about cultural background that permits determinations of both physical characteristics and certain demographic factors. Other demographic factors may be determined from accents, which may be correlated both with cultural background and level of affluence in some instances. Acoustic factors that permit inferences of emotional level include both intensity levels and pause patterns, both of which may indicate a state of agitation or calmness in the speaker. In addition, the identification of certain sound patterns incidental to speech, like groaning, sighing, laughter, screaming, and the like also provide information regarding the speaker's emotional state. A decision engine in the form of a voice-analysis module 236-2 may combine this type of information to evaluate voice components of collected acoustic data.

Similar types of analyses may be performed with animal sounds, permitting an identification of the species of animal 338 and its emotional level 340. Although the specific sounds are different, the same principles apply as used in the analysis of human voices. Specifically, identification of certain sounds permit an inference that a certain species of animal, such as a cat or dog, is currently in the environment, and the frequency characteristics may permit an estimation of the size of the animal. Sounds like growling, barking, yelping, or purring provide different indications of the emotional state of the animals. These various kinds of inferences may be made by a decision engine in the form of an animal-analysis module 236-3.

The sounds emitted by various types of alarms may also be detected, and their specific frequency characteristics may permit discrimination of the type of alarm, which could be a smoke alarm 342, an alarm issued by a carbon monoxide detector 344, or an intruder alarm 346 in different embodiments. A decision engine in the form of an alarm-analysis module 236-4 may combine information from these different types of analyses.

The examples provided above are not intended to be exhaustive since there are numerous other sources of acoustic information—ringing telephones, whistling kettles, heart monitors, pumps, breaking glass, gunshots, tire squeals, etc. Any of these, and many not mentioned, also potentially contain information that may be used analytically by the system in monitoring an environment. A comprehensive evaluation of the environment may be provided by an acoustic-scene correlation-analysis module 310 that combines information from each of the individual types of classification. With such a module, the information combines synergistically, permitting inferences that might be improbable with only a single source of information to be reinforced with other information. Similarly, certain otherwise strong inferences may be discounted because of conflicting inferences provided by other sources of information. The determinations made by the acoustic-scene correlation-analysis module may advantageously make use of external information 320 that specifies the date, time, weather conditions, etc. A response module 315 may use the determinations made by the acoustic-scene correlation-analysis module 310 to initiate a response to the overall evaluation of the environment as dictated by suitable rules.

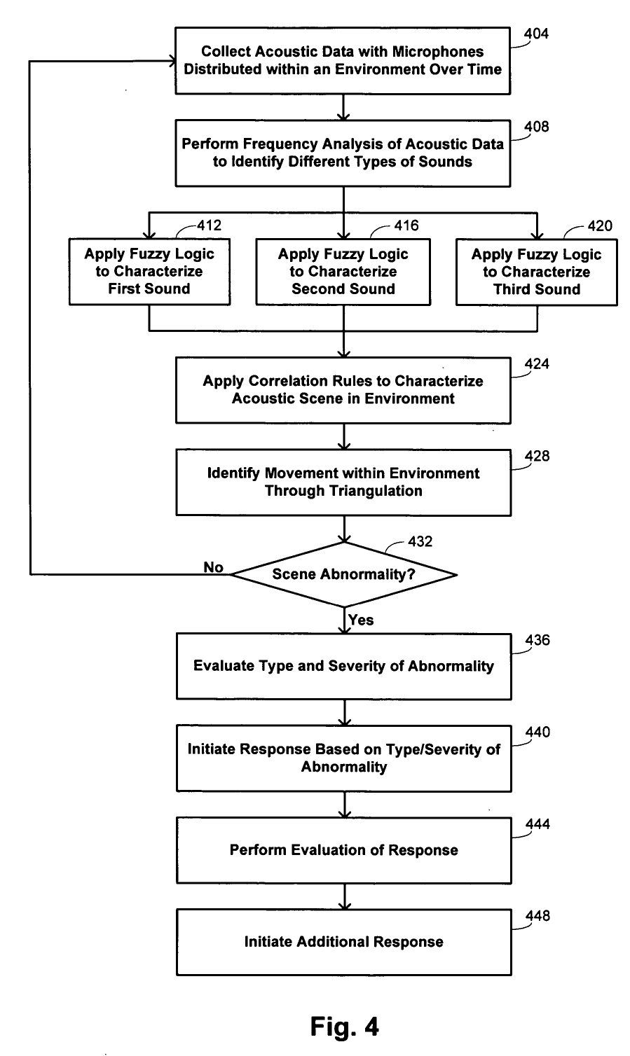

In describing the logical structure of the system, some reference has been made to methods by which embodiments of the invention may be limited. Such a description is now provided in more detail with reference to FIG. 4, which is a flow diagram that summarizes various aspects of responding to anomalous acoustic environments. As indicated at block 404, such methods may begin with the collection of acoustic data using the microphones that have been distributed within the environment. The data are collected over time and subjected to a frequency analysis as indicated at block 408 to discriminate a potential superposition of multiple sound types. This results in an identification of a plurality of separate sound patterns, either derived by discriminating among multiple sound patterns received simultaneously by one or more microphones, or by identifying substantially discrete sound patterns received by different microphones.

Fuzzy-logic techniques are applied to each of the discriminated sounds to characterize them, as indicated at blocks 412, 416, and 420. How the sounds are characterized may depend on a number of factors. First, each sound may be characterized as representing a certain type of sound, such as a human voice, an animal sound, an alarm sound, a sound drawn from the surroundings of the environment, or the like. With such an initial assignment, a more detailed assessment of the sound may be performed, a number examples of which were described in connection with FIG. 3. As previously noted, these characterizations may be drawn by performing comparisons of the distinct sounds with sound signatures known to be representative of certain characteristics. While the drawing shows that such an analysis is performed for three distinct sounds, the invention is not limited by any particular number for the plurality of sounds.

The various characterizations derived from the sounds indicate separate aspects of a state of the environment. In some instances, such indications may be probabilistic, such as where a sound is ambiguous and is characterized by different probabilities that it corresponds to different circumstances. The probabilistic nature of a sound might also be reflected with a relative certainty of the type of sound, but with an assignment of probabilities to the narrower characterization of the sound. For instance, a sound might be identified as a human voice speaking at unusual high volume, with the characterization assigning different probabilities that the emotional state of the speaker is one of anger or one of enthusiastic excitement, both of which might result in a similar sound pattern.

The various sound characterizations are combined at block 424 with a set of correlation rules. These correlation rules may use weighting factors to assign relative levels of importance to certain types of sounds in drawing an ultimate inference about activity in the environment. As such, an “acoustic scene” is developed from the sounds collected from the microphones as to what actions are taking place in the environment. Development of such an acoustic scene may advantageously take advantage of the ability to perform triangulation functions with the plurality of microphones to identify positions within the environment where sounds originate. The change of such positions over time permits movement of sound sources within the environment to be identified as indicated at block 428.

The resulting scene is monitored, with characteristics of the environment evolving over time. A check is made periodically or continuously at block 432 whether the acoustic scene is considered normal or anomalous according to defined rules. If the scene is identified as anomalous, the type of anomaly and its severity are evaluated at block 436. This permits an appropriate response to be initiated at block 440. In some instances, this may be merely an initial response, with the system continuing to monitor the environment to assess the effectiveness of the response at block 444. If the initial response was insufficient, an additional response might be initiated at block 448.

For instance, if a scene abnormality is detected that suggests a 40% probability that a homeowner's premises have been invaded by an intruder, an initial response might be to transmit an alert to the homeowner. If such a transmission does not result in any indication from the homeowner that there are no actual problems, and the continued monitoring of the premises shows an increase in the probability of invasion to 85%, an additional response may be notification of law-enforcement authorities. In another example, the identification of an audio scene abnormality may trigger the activation of additional sensors that collect different types of information, such as video information. The additional response may be based on an evaluation of the subsequently collected video data in combination with the audio data. This represents a judicious use of bandwidth by invoking the high-bandwidth video or other sensor collection only once the relatively low-bandwidth audio collection has identified a potential issue.

Monitoring of the scene may also include the generation of a graphical user interface, in which a visual display of information derived from the acoustic analysis is generated for consideration by a human operator. With such an interface, a global map could show positions of relevant parties or objects within the acoustic scene and include labels that act as indicators of deductions made from the acoustic analysis. For instance a global map could show positions of participants in a conversation, with indicators of their age, sex, health, country of origin, emotional state, and the like. In some instances, such indicators could be presented in the form of a variable display, such as where different colors are used to indicate different emotional states or bars of different lengths are used to indicate age.

The display provided by the graphical user interface could be at different scales, and could be amenable to scale changes. This would permit detailed information of activity within a building to be monitored, as well as to provide a more global indication of events taking place outside the building. Vectors or other movement indicators may be superimposed to summarize information related to the motion of humans or objects. The display may include features that permit drilling down to more detailed information, such as links to sensor health and status information, event ticket summaries, dossiers, and the like. The display may itself generate auditory alarms, such as to indicate movement of a human into a restricted area. Certain supplementary support features may additionally be provided, such as a clock, a summary of logged-in users, instant messaging capability, and the like.

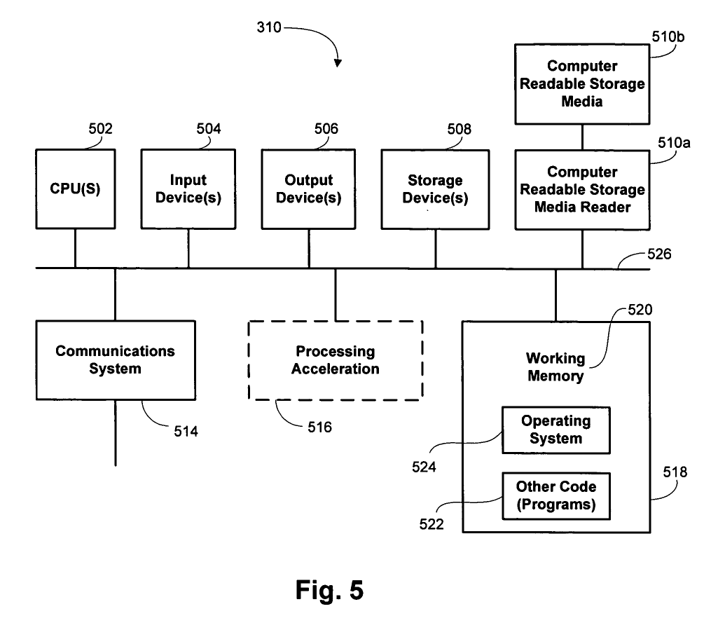

FIG. 5 provides a schematic illustration of a structure that may be used to implement the monitoring system 116. A similar structure may also be used to implement the various modules and engines described in connection with FIGS. 1-3. FIG. 5 broadly illustrates how individual system elements may be implemented in a separated or more integrated manner. The system 116 is shown comprised of hardware elements that are electrically coupled via bus 526, including a processor 502, an input device 504, an output device 506, a storage device 508, a computer-readable storage media reader 510a, a communications system 514, a processing acceleration unit 516 such as a DSP or special-purpose processor, and a memory 518. The computer-readable storage media reader 510a is further connected to a computer-readable storage medium 510b, the combination comprehensively representing remote, local, fixed, and/or removable storage devices plus storage media for temporarily and/or more permanently containing computer-readable information. The communications system 514 may comprise a wired, wireless, modem, and/or other type of interfacing connection and permits data to be exchanged with the analysis module 112, active layer 108, databases 124, support network 128, monitor 140 and external interfaces 120.

The system 116 also comprises software elements, shown as being currently located within working memory 520, including an operating system 524 and other code 522, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

### EXAMPLES

A number of examples are described below to illustrate applications for embodiments of the invention. Such examples are not intended to be limiting, but to show how certain features of the system may be used in particular circumstances.

1. Home Environment

In a first example, the environment comprises a residential home equipped with a variety of conventional alarm devices, including smoke detectors, a carbon monoxide detector, and a motion detector. The system of the invention applies a rules engine on top of the audio output of these conventional devices, coupled with detection of other sounds within the home. The motion detector does not provide audio output so it has no relevance to a strictly acoustic analysis, but could in some embodiments additionally be monitored to provide further information used in evaluating a state of the home environment.

Activation of one or more of the conventional alarm devices, coupled with identification of water-flow noises, the sound of breaking glass or breaking of a door jamb, and/or the sound of a barking dog could be used to infer that the home is being damaged by flooding, is being broken into, is on fire, has toxic levels of carbon monoxide, etc. If the sound of a telephone ringing without being answered is detected, this could be used to infer with different probabilities that no one is home or that someone at the home is injured or incapacitated. The probabilities may reflect statistical determinations that it is much more likely the premises are vacant than that a person has been incapacitated by assigning respective probabilities to each possibility of 90% and 10%.

More subtle inferences could also be made with a rules engine in which the sound of a human being moving is detected at odd hours or there is a lack of motion sounds at a time when there would ordinarily be movement. Additional subtle inferences may be made upon detection of relative sounds of movement of multiple individuals and/or the quality of the pattern of their conversation. Sounds indicating significant movement by an individual or individuals could suggest a state of agitation, nervousness, or physical altercation. The type of footstep movement may allow inferences about age, health, identity, and/or weight of individuals. Additional health inferences may be made on the basis of the number of times a toilet is flushed, providing an indicator of prostate or bladder function.

Other sounds having an origin outside the premises, but still detected by microphones located within the premises may also impact the inferences drawn by the system. Sounds such as police, ambulance, or fire sirens, or the report of gunshots, allow for additional inferences with respect to the audio scene analysis and situational awareness.

In terms of human conversation, breathing, crying, couching, laughter, etc., together with the tone, volume, cadence, and frequency of voices or sounds may provide indicators of such characteristics as age, sex, health, weight, mental or emotional state, and perhaps also country or region of origin as reflected in dialect or linguistic differences. Additional inferences may be made on wealth, vocation, spending patterns, age, education level, etc. based on the radio station or television station selection, or the use of video or computer games, the presence or lack of a facsimile machine or the sound of computer keys being clicked. The times when an alarm clock sounds, and its frequency and duration of usage, may provide similar information. Additional inferences, such as current weather conditions and the health and status of equipment may be made from sounds of heating and air-conditioning equipment, the sound of rain, wind, etc. The tone or sound of the dial-pad input of a telephone may be detected to infer that long-distance calls are being made, etc.

2. Retail Environment

Many of the characteristics described in connection with the home environment may also be useful when the environment is a retail environment, such as a store or shopping mall. Additional inferences related to consumer behavioral analysis may be made in such an environment by identifying where customers are aggregating, whether they are interested in a particular set of products, what their emotional reaction is to a particular product or store, as evidenced by various conversational signatures like those described above. Other inferences in a retail environment may be related to identifying potential theft. Possible theft by an employee may be inferred from the sound of a locked storeroom or safe door being opened at inappropriate times, or by the sound of a cash-register drawer being opened without a sales transaction. Possible theft by a customer may be inferred from sounds of items being secreted away, with a subsequent sound of the customer leaving without paying for an item.

3. Institutional Environment

Various institutional environments may be monitored in some embodiments. For example, rooms within a hospital environment may be monitored to detect acoustic output of a heart monitor, activation of a nurse call button, the rhythm of a breathing machine or other patient monitoring equipment, and the like. Other inferences may be drawn from other institutional environments, such as within a prison or in a house-arrest situation where sounds from electronic tag monitors may be detected.

4. Public Environment

Examples of public environments include subway and train stations, airports, sports arenas, cinemas, and other entertainment areas. In such environments, the sounds of a group of people running may suggest an anomaly related to a potential theft, assault, or other crime. The application of triangulation may better define locations, movement, and speed of the people, indicating a possible location for the source of the anomaly.

5. Identification of Sabotage and Terrorist Activities

In port or dock applications, the audio-scene analysis and situational awareness described herein permit inferences to be drawn that provide early indications of theft, contraband activity, or potential terrorism. They may also be applied to entire distribution systems, such as water-, oil-, or chemical-distribution systems to determine the particular nature of activities taking place based on audio inputs, and whether such activity is normal or anomalous. Military and intelligence applications may also benefit from the analysis described herein to identify improvised explosive devices in a variety of environments. Identifications of anomalies in any of these environments permits decisions to be made to notify appropriate response authorities.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of monitoring an environment, the method comprising:
receiving acoustic data collected from a plurality of microphones distributed within the environment;
identifying sound sources from the received acoustic data as generative of sound detected by the microphones;
characterizing an acoustic scene of the environment by application of acoustic-scene characterization rules to the received acoustic data;
identifying the acoustic scene of the environment as anomalous according to parameter values deviant from a set of parameter values defining nonanomalous acoustic scenes; and
initiating a remedial response to the environment in response to identifying the acoustic scene of the environment as anomalous.

2. The method recited in claim 1 further. comprising determining a quality of each of the identified sound sources by application of sound-quality rules to the received acoustic data, wherein the acoustic scene of the environment is further characterized by application of the acoustic-scene characterization rules to the determined quality of the identified sound sources.

3. The method recited in claim 2 wherein:
one of the sound sources comprises a human voice sound made by a human being; and
the quality of the one of the sound sources comprises a determined emotional state of the human being.

4. The method recited in claim 2 wherein:
one of the sound sources comprises a human voice sound made by a human being; and
the quality of the one of the sound sources comprises determined physical characteristics of the human being.

5. The method recited in claim 2 wherein:
one of the sound sources comprises a human voice sound made by a human being; and
the quality of the one of the sound sources comprises determined demographic characteristics of the human being.

6. The method recited in claim 2 wherein:
one of the sound sources comprises an alarm device; and
the quality of the one of the sound sources comprises an active alarm state of the alarm device.

7. The method recited in claim 2 wherein:
one of the sound sources comprises atmospheric weather; and
the quality of the one of the sound sources comprises weather conditions around the environment.

8. The method recited in claim 2 wherein:
one of the sound sources comprises a siren outside the environment; and
the quality of the one of the sound sources comprises a determined motion of the siren towards or away from the environment.

9. The method recited in claim 2 wherein the sound-quality rules comprise fuzzy-logic rules and determining the quality of each of the identified sound sources comprises applying the fuzzy-logic rules to the received acoustic data.

10. The method recited in claim 1 wherein at least one of the identified sound sources is outside the environment.

11. The method recited in claim 1 further comprising:
evaluating a result of the remedial response; and
initiating a second response to the environment in accordance with evaluating the result of the remedial response.

12. The method recited in claim 11 wherein:
initiating the remedial response to the environment comprises activating video monitoring of at least a portion of the environment.

13. The method recited in claim 1 further comprising determining a motion pattern of at least some of the identified sound sources within the environment by triangulating positions of the at least some of the identified sound sources over time with the received acoustic data.

14. The method recited in claim 1 wherein the acoustic-characterization rules comprise fuzzy-logic rules and characterizing the acoustic scene of the environment comprises applying the fuzzy-logic rules to the received acoustic data to perform a comparison of the received acoustic data with standardized sound signatures.

15. The method recited in claim 1 further comprising receiving data external to the environment, wherein the acoustic scene of the environment is further characterized by application of the acoustic-scene characterization rules to the data external to the environment.

16. A method of monitoring an environment, the method comprising:
receiving acoustic data collected from a plurality of microphones distributed within the environment;
identifying sound sources from the received acoustic data as generative of the sound detected by the microphones;
determining a quality of each of the identified sound sources by application fuzzy-logic sound quality rules to the received acoustic data;
receiving data external to the environment;
determining a motion pattern of at least some of the identified sound sources within the environment by triangulating positions of the at least some of the identified sound sources over time with the received acoustic data;
characterizing an acoustic scene of the environment by application of fuzzy-logic acoustic-scene characterization rules to the received acoustic data, determined quality of the identified sound sources, received data external to the environment, and determined motion pattern;
identifying the acoustic scene of the environment as anomalous according to parameter values deviant from a set of parameter values defining nonanomalous acoustic scenes; and
initiating a remedial response to the environment in response to identifying the acoustic scene of the environment as anomalous.

17. The method recited in claim 16 wherein initiating the remedial response to the environment comprises activating video monitoring of at least a portion of the environment, the method further comprising initiating a second response to the environment in accordance with evaluating the video monitoring.

18. A system for monitoring an environment, the system comprising:
a plurality of microphones distributed within the environment;
a sound-identification system in communication with the plurality of microphones and having programming instructions to identify sound sources from the received acoustic data as generative of sound detected by the microphones;
an acoustic-scene characterization system in communication with the sound-identification system and having:
programming instructions to characterize an acoustic scene of the environment by application of acoustic-scene characterization rules to the received acoustic data; and
programming instructions to identify the acoustic scene of the environment as anomalous according to parameter values deviant from a set of parameter values defining nonanomalous acoustic scenes; and
a response system in communication with the acoustic-scene characterization system and having programming instructions to initiate a remedial response to the environment in response to identifying the acoustic scene of the environment as anomalous.

19. The system recited in claim 16 wherein:
the sound-identification system further has programming instructions to determine a quality of each of the identified sound sources by application of sound-quality rules to the received acoustic data; and
the acoustic scene of the environment is further characterized by application of the acoustic-scene characterization rules to the determined quality of the identified sound sources.

20. The system recited in claim 19 wherein the sound-quality rules comprise fuzzy-logic rules.

21. The system recited in claim 18 wherein the acoustic-scene characterization rules comprise fuzzy-logic rules.

22. The system recited in claim 18 wherein at least one of the identified sound sources is outside the environment.

23. The system recited in claim 18 wherein the response system further has:
programming instructions to evaluate a result of the remedial response; and
programming instructions to initiate a second response to the environment in accordance with evaluating the result of the remedial response.

24. The system recited in claim 23 wherein the programming instructions to initiate the remedial response to the environment comprise programming instructions to activate video monitoring of at least a portion of the environment.

25. The system recited in claim 18 wherein the sound-identification system further has programming instructions to determine a motion pattern of at least some of the identified sound sources within the environment by triangulating positions of the at least some of the identified sound sources over time with the received acoustic data.

26. The system recited in claim 18 wherein the programming instructions to characterize the acoustic scene of the environment include programming instructions to apply the acoustic-scene characterization rules to data external to the environment.
